(19) United States
(12) Patent Application Publication
(10) Pub. No.: US 2024/0096189 A1
(43) Pub. Date: Mar. 21, 2024

(54) VEHICLE OUTSIDE MONITORING APPARATUS, MONITORING SERVICE CENTER, AND VEHICLE OUTSIDE MONITORING METHOD

(71) Applicant: Mitsubishi Electric Corporation, Tokyo (JP)

(72) Inventors: Mitsuo SHIMOTANI, Tokyo (JP); Tadashi MIYAHARA, Tokyo (JP); Keisaku FUKUDA, Tokyo (JP); Kuniyo IEDA, Tokyo (JP); Takashi IRIE, Tokyo (JP)

(73) Assignee: Mitsubishi Electric Corporation, Tokyo (JP)

(21) Appl. No.: 18/272,760

(22) PCT Filed: Mar. 30, 2021
(86) PCT No.: PCT/JP2021/013628

§ 371 Date: Jul. 17, 2023

(51) Int. Cl. G08B 21/02; B60Q 1/50; B60Q 5/00; B60W 60/00; H04N 7/18

(52) U.S. Cl. CPC G08B 21/02; B60Q 1/50; B60Q 5/005; B60W 60/001; H04N 7/185

(57) ABSTRACT

An object of the present disclosure is to provide a vehicle outside monitoring apparatus capable of appropriately dealing with an attention-requiring state when a specific target object other than the subject vehicle or target person is in the attention-requiring state. A vehicle outside monitoring apparats according to the present disclosure includes: a monitoring target information acquisition unit acquiring monitoring target information of at least one monitoring target located around a subject vehicle; a periphery information acquisition unit acquiring periphery information around the subject vehicle; an attention-requiring state determination unit determining whether or not the monitoring target is in an attention-requiring state based on the monitoring target information and the periphery information; and a controller controlling the subject vehicle so that the subject vehicle avoids the attention-requiring state when the attention-requiring state determination unit determines that the monitoring target is in the attention-requiring state.

### TECHNICAL FIELD

The present disclosure relates to a vehicle outside monitoring apparatus, a monitoring service center, and a vehicle outside monitoring method for monitoring a monitoring target located around a subject vehicle.

### BACKGROUND ART

Conventionally commodified is a technique of recognizing a suspicious person located outside a vehicle and providing an alarm or a notice to prevent damage such as a property loss during parking a vehicle, for example (Patent Document 1, for example). Commodified is a vehicle traveling data recorder recording a state leading to an accident when a vehicle meets with the accident.

### PRIOR ART DOCUMENTS

### Patent Document(s)

Patent Document 1: Japanese Patent Application Laid-Open No. 2008-123057

### SUMMARY

### Problem to be Solved by the Invention

The conventional technique described above is effective in protecting the subject vehicle or performing verification at a time when the subject vehicle meets the accident. but cannot appropriately deal with an attention-requiring state when a specific target object other than the subject vehicle or a target person is in the attention-requiring state.

The present disclosure therefore has been made to solve problems as described above, and it is an object of the present disclosure to provide a vehicle outside monitoring apparatus, a monitoring service center, and a vehicle outside monitoring method capable of appropriately dealing with an attention-requiring state when a specific target object other than the subject vehicle or a target person is in the attention-requiring state.

### Means to Solve the Problem

In order to solve the problem described above, a vehicle outside monitoring apparats according to the present disclosure includes: a monitoring target information acquisition unit acquiring monitoring target information as information of at least one monitoring target located around a subject vehicle; a periphery information acquisition unit acquiring periphery information as information around the subject vehicle; an attention-requiring state determination unit determining whether or not the monitoring target is in an attention-requiring state based on the monitoring target information acquired by the monitoring target information acquisition unit and the periphery information acquired by the periphery information acquisition unit; and a controller controlling the subject vehicle so that the subject vehicle avoids the attention-requiring state when the attention-requiring state determination unit determines that the monitoring target is in the attention-requiring state.

### Effects of the Invention

According to the present disclosure, the vehicle outside monitoring apparats includes the attention-requiring state determination unit determining whether or not the monitoring target is in the attention-requiring state and the controller controlling the subject vehicle so that the subject vehicle avoids the attention-requiring state when the attention-requiring state determination unit determines that the monitoring target is in the attention-requiring state, thus can appropriately deal with the attention-requiring state when a specific target object other than the subject vehicle or a target person is in the attention-requiring state.

These and other objects, features, aspects and advantages of the present disclosure will become more apparent from the following detailed description when taken in conjunction with the accompanying drawings.

### BRIEF DESCRIPTION OF DRAWINGS

FIG. 1 A block diagram illustrating an example of a configuration of a vehicle outside monitoring apparatus according to an embodiment 1.

FIG. 2 A block diagram illustrating an example of the configuration of the vehicle outside monitoring apparatus according to the embodiment 1.

FIG. 3 A flow chart illustrating an example of an operation of the vehicle outside monitoring apparatus according to the embodiment 1.

FIG. 4 A diagram illustrating an example of a monitoring target setting screen according to the embodiment 1.

FIG. 5 A diagram for explaining an attention-requiring state according to the embodiment 1.

FIG. 6 A diagram for explaining an attention-requiring state avoidance according to the embodiment 1.

FIG. 7 A diagram illustrating an example of a relationship between the attention-requiring state and attention-requiring state avoiding processing according to the embodiment 1.

FIG. 8 A diagram for explaining an attention-requiring state avoidance according to the embodiment 1.

FIG. 9 A diagram for explaining an attention-requiring state avoidance according to the embodiment 1.

FIG. 10 A block diagram illustrating an example of a configuration of a vehicle outside monitoring apparatus according to an embodiment 2.

FIG. 11 A flow chart illustrating an example of an operation of the vehicle outside monitoring apparatus according to the embodiment 2.

FIG. 12 A diagram illustrating an example of a monitoring plan design screen according to the embodiment 2.

FIG. 13 A block diagram illustrating an example of a configuration of a monitoring service center according to an embodiment 3.

FIG. 14 A flow chart illustrating an example of an operation of the monitoring service center according to the embodiment 3.

FIG. 15 A flow chart illustrating an example of an operation of the monitoring service center according to the embodiment 3.

FIG. 16 A diagram illustrating an example of a monitoring request screen according to the embodiment 3.

FIG. 17 A diagram illustrating an example of a hardware configuration of the vehicle outside monitoring apparatus according to the embodiment 1.

FIG. 18 A diagram illustrating an example of a hardware configuration of the vehicle outside monitoring apparatus according to the embodiment 1.

### DESCRIPTION OF EMBODIMENT(S)

### Embodiment 1

<Configuration>

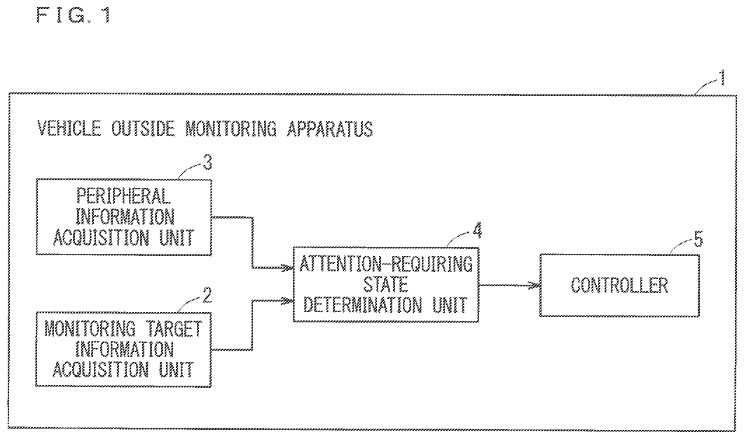

FIG. 1 is a block diagram illustrating an example of a configuration of a vehicle outside monitoring apparatus 1 according to an embodiment 1. FIG. 1 illustrates a bare minimum of configuration constituting the vehicle outside monitoring apparatus according to the embodiment 1.

The vehicle outside monitoring apparatus 1 includes a monitoring target information acquisition unit 2, a periphery information acquisition unit 3, an attention-requiring state determination unit 4, and a controller 5.

The monitoring target information acquisition unit 2 acquires monitoring target information as information of a monitoring target located around the subject vehicle. The periphery information acquisition unit 3 acquires periphery information as information of an area around the subject vehicle.

The attention-requiring state determination unit 4 determines whether or not the monitoring target is in an attention requiring state based on the monitoring target information acquired by the monitoring target information acquisition unit 2 and the periphery information acquired by the periphery information acquisition unit 3. When the attention-requiring state determination unit 4 determines that the monitoring target is in the attention-requiring state, the controller 5 controls the subject vehicle so that the subject vehicle avoids the attention-requiring state.

Described next is the other configuration of the vehicle outside monitoring apparatus including the vehicle outside monitoring apparatus 1 illustrated in FIG. 1.

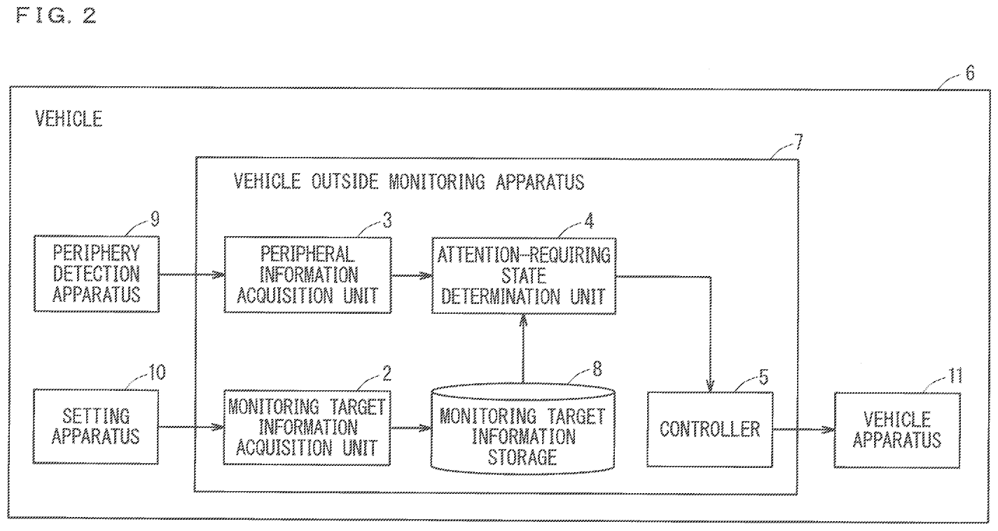

FIG. 2 is a block diagram illustrating an example of a configuration of a vehicle outside monitoring apparatus 7 according to the other configuration.

The vehicle outside monitoring apparatus 7 includes the monitoring target information acquisition unit 2, the periphery information acquisition unit 3, the attention-requiring state determination unit 4, the controller 5, and a monitoring target information storage 8. The vehicle outside monitoring apparatus 7 is connected to a periphery detection apparatus 9, a setting apparatus 10, and a vehicle apparatus 11. The vehicle outside monitoring apparatus 7, the periphery detection apparatus 9, the setting apparatus 10, and the vehicle apparatus 11 are mounted on a vehicle 6.

The vehicle outside monitoring apparatus 7 can be applied not only to an in-vehicle navigation apparatus, that is to say, a car navigation apparatus but also a navigation apparatus built as a system by appropriately combining a portable navigation device (PND) which can be mounted on a vehicle and a server provided outside the vehicle or an apparatus other than the navigation apparatus built as the system. In this case, each function or each constituent element of the vehicle outside monitoring apparatus 7 is separately disposed in each function constituting the system described above.

The periphery information acquisition unit 3 acquires periphery information as information of an area around the vehicle 6 (subject vehicle) from the periphery detection apparatus 9. The periphery detection apparatus 9 detects a state around the vehicle 6. Examples of the periphery detection apparatus 9 include a set of a visible light or infrared light imaging apparatus and an image identifying apparatus, a sound recognition apparatus, a light detection and ranging (Lider), an ultrasonic sensor, a millimeter-wave radar, and a vibration recognition apparatus, and they may be combined.

The monitoring target information acquisition unit 2 acquires monitoring target information as information of a monitoring target located around the vehicle 6 from the setting apparatus 10. Examples of the monitoring target include a moving body including a person. The monitoring target information includes a position of the monitoring target, an image including the monitoring target, an ID of a mobile terminal held by a person when the monitoring target is a person, for example. The position of the monitoring target includes an absolute position of the monitoring target or a relative position of the monitoring target with respect to the vehicle 6.

The setting apparatus 10 is an apparatus used when the monitoring target is set. Examples of the setting apparatus 10 include a display operation apparatus in which a display apparatus and a touch panel are integrally made and a communication apparatus which can be communicated with a communication terminal such as a smartphone.

The monitoring target information storage 8 stores the monitoring target information acquired by the monitoring target information acquisition unit 2. The monitoring target information storage 8 may be provided outside the vehicle outside monitoring apparatus 7.

The attention-requiring state determination unit 4 determines whether or not the monitoring target is in an attention requiring state based on the monitoring target information stored in the monitoring target information storage 8 and the periphery information acquired by the periphery information acquisition unit 3.

When the attention-requiring state determination unit 4 determines that the monitoring target is in the attention-requiring state, the controller 5 controls the vehicle apparatus 11 so that the vehicle apparatus 11 avoids the attention-requiring state. The vehicle apparatus 11 is operated to avoid the attention-requiring state in the monitoring target. Examples of the vehicle apparatus 11 include a lighting apparatus, a sound alarm apparatus, an automatic traveling control apparatus, and a communication apparatus.

<Operation>

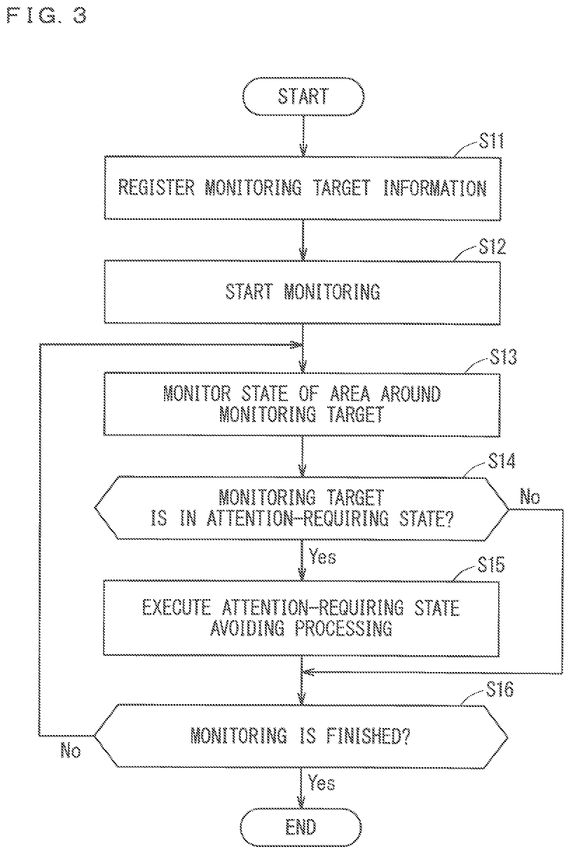

FIG. 3 is a flow chart illustrating an example of an operation of the vehicle outside monitoring apparatus 7. Described hereinafter is an example of a case of going camping and staying in a tent. There is no limitation on a drive system, such as an engine driving automobile, an electrical automobile, or a fuel-cell automobile, in the vehicle 6. In a process of recording the monitoring target information in Step S11 in FIG. 3 and a process until instructing a start of monitoring in Step S12, an engine or a motor power source for vehicle driving may be in an ON state or OFF state. However, at a point of time when the monitoring operation is started in Step S12, the engine or the motor power source for vehicle driving in the vehicle 6 is preferably in the OFF state to prevent wasteful consumption of energy. After the monitoring is started, the vehicle outside monitoring apparatus 7 and the periphery detection apparatus 9 are in ON state. It is also applicable that the vehicle apparatus 11 enters the ON state after the monitoring is started, and the controller 5 controls the vehicle apparatus 11 so that the vehicle apparatus 11 is in the OFF state after the monitoring is started and enters the ON state as necessary. It is also applicable that the setting apparatus 10 is the ON state until the monitoring target is set and enters the OFF state after the monitoring target is set, or is always in the ON state when performing communication with an apparatus outside the vehicle 6.

In Step S11, the monitoring target information acquisition unit 2 acquires the monitoring target information from the setting apparatus 10, and stores it in the monitoring target information storage 8. Accordingly, the monitoring target information is registered in the monitoring target information storage 8. Methods of (a) to (f) described hereinafter or a combination thereof, for example, are considered as a method of registering the monitoring target information.

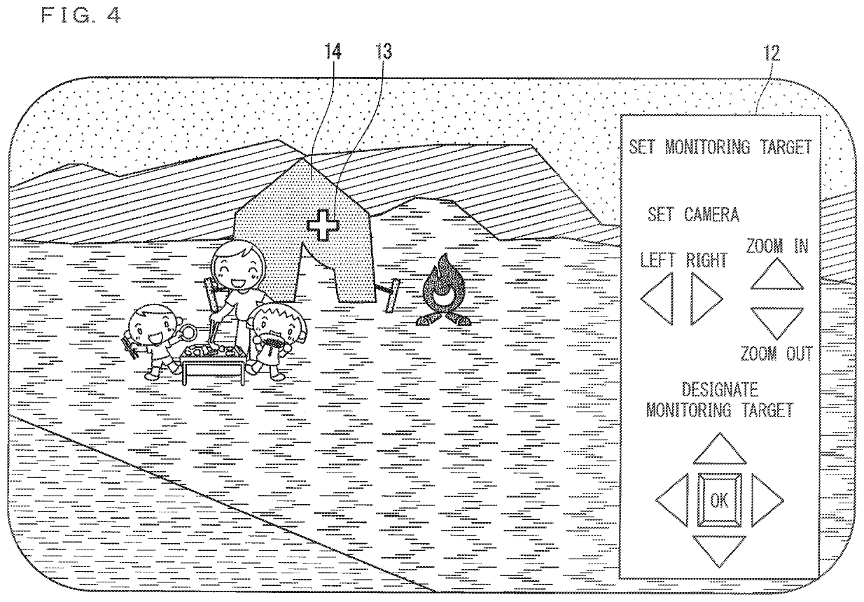

(a) A video including a tent taken by the periphery detection apparatus 9 (imaging apparatus) is displayed on the setting apparatus 10 (display operation apparatus), and when a user selects the tent in the video, the tent becomes the monitoring target. For example, a monitoring target setting screen illustrated in FIG. 4 is displayed on the display operation apparatus. The monitoring target setting screen includes the video taken by the imaging apparatus and a setting window 12. Located in an upper portion of the setting window 12 (monitoring target setting) are a button for changing a direction of the imaging apparatus to right and left and a button for zooming the video. Located on a lower portion of the setting window 12 (monitoring target designation) are a button for moving a cursor 13 in the video from side to side and up and down and a determination button determining the monitoring target. In the example in FIG. 4, the user moves the cursor 13 to be overlapped with the tent 14 and selects the determination button. Accordingly, the tent 14 is registered as the monitoring target. The plurality of monitoring targets may be selected.

It is also applicable to combine the plurality of videos to generate a bird's-eye view video viewing a periphery from an upper side of the vehicle 6, and display the bird's-eye view video on the display operation apparatus. It is also applicable that the user turns on a signal of a specific optical lighting apparatus at a position where the monitoring target is located, and the periphery detection apparatus 9 detects the position of the lighting apparatus, thereby recognizing a relative position of the monitoring target with respect to the vehicle 6.

(b) The video of the tent taken by the imaging apparatus outside the vehicle 6 is transmitted to the setting apparatus 10 (communication apparatus), and the relative position of the tent with respect to the vehicle 6 is image-recognized in the setting apparatus 10. In this case, the setting apparatus 10 has a function of image recognition processing. Accordingly, the tent is registered as the monitoring target, and the relative position of the tent is also registered. The imaging apparatus outside the vehicle 6 may be a communication terminal such as a smartphone held by a monitoring target person or a related person of the vehicle 6, for example.

(c) Positional information is transmitted to the vehicle 6 by the user located in the tent using a communication terminal. In this case, the communication terminal has a positional information acquisition function such as a global positioning system (GPS), and the setting apparatus 10 (communication apparatus) receives the positional information transmitted from the communication terminal. Accordingly, an absolute position of the tent as the monitoring target is registered. Any apparatus is applicable to the communication terminal as long as it can perform authentication, such as an electronic key or a smartphone.

(d) A map of a peripheral area including the position of the vehicle 6 is displayed on the setting apparatus 10 (display operation apparatus), and the monitoring target is selected on the map. Accordingly, the monitoring target and an absolute position of the monitoring target are registered. It is also applicable that the periphery detection apparatus 9 (imaging apparatus) takes an images of an actual position corresponding to the position selected on the map, and the taken image is displayed on the setting apparatus 10 (display operation apparatus) so that the user matches the position on the map to the actual position.

(e) When the monitoring target is a family, it is also applicable to previously store a picture of the family using the setting apparatus 10 and image-recognize the picture by the periphery detection apparatus 9 (a set of the imaging apparatus and the image recognition apparatus), thereby confirming presence of the monitoring target. The picture of the family may be stored in the monitoring target information storage 8. The monitoring target is not limited to the family, however, a group made up of a plurality of persons is also applicable.

(f) It is also applicable to previously store IDs of a communication terminal held by each member of a family when the monitoring target is the family, and receive the ID of each communication terminal using the setting apparatus 10 (communication apparatus), thereby confirming the position of each member. The ID of the communication terminal held by each member may be stored in the monitoring target information storage 8. The monitoring target is not limited to the family, however, a group made up of a plurality of persons is also applicable.

Returning to the description of FIG. 3, the monitoring operation of monitoring the monitoring target is started by a predetermined monitoring start operation in Step S12. Considered as the start of the monitoring operation is, for example, start by performing a predetermined operation (a monitoring start button displayed on the setting apparatus 10 is selected) after the monitoring target is set using the setting apparatus 10, start by pressing a dedicated monitoring start button provided to the vehicle 6, or start by transmitting a monitoring start command to the vehicle 6 from a communication terminal outside the vehicle 6.

In Step S13, the attention-requiring state determination unit 4 monitors a state around the monitoring target based on the peripheral information acquired from the periphery detection apparatus 9 by the periphery information acquisition unit 3 and the monitoring target information stored in the monitoring target information storage 8. When an area around the monitoring target is dark, the area may be illuminated. It is also applicable that the monitoring in Step S13 is executed in a constant cycle (for example, every thirty seconds) and is executed in a short cycle (for example, every one second) when the monitoring target is in the attention-requiring state so that power consumption of the periphery detection apparatus 9 is reduced. It is also applicable that the periphery detection apparatus 9 (sound recognition apparatus) always executes monitoring, and switches a cycle of monitoring by the other periphery detection apparatus 9 from thirty seconds to continuous monitoring when the sound recognition apparatus detects abnormality, for example. When the attention-requiring state is avoided, the cycle may be returned to the original cycle of monitoring.

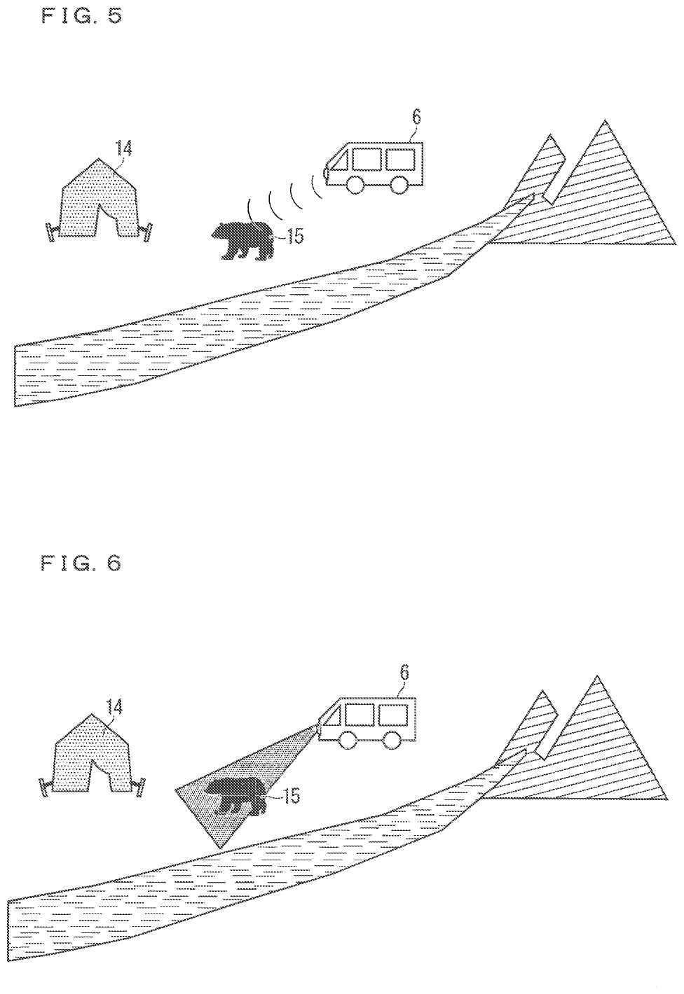

In Step S14, the attention-requiring state determination unit 4 determines whether or not the monitoring target is in the attention-requiring state. When the monitoring target is in the attention-requiring state, the process proceeds to Step S15. In the meanwhile, when the monitoring target is not in the attention-requiring state, the process proceeds to Step S16. FIG. 5 illustrates a state where a bear 15 which is a wildlife gets close to the tent 14 as the monitoring target. In this case, the attention-requiring state determination unit 4 determines that the tent 14 is in the attention-requiring state.

Herein, a determination whether or not an object is a wildlife can be performed based on a determination whether or not the object is an animal which may cause harm to a person. In this case, the determination may be performed based on a type of animals, and animals which are hardly considered pet animals of a person and may cause harm thereto such as bears, deer, foxes, skunks, and alligators may be determined wildlife without condition. It is also applicable that as for dogs and cats, an image of a pet animal of a person or a related person of the vehicle 6 as the monitoring target is previously registered, and an animal other than the pet animal is determined to be wildlife when the periphery detection apparatus 9 (a set of the imaging apparatus and the image recognition apparatus) performs image recognition. A terminal transmitting an identification signal may be mounted on the pet animal. Furthermore, it is also applicable to notify a person as the monitoring target of an animal getting close to the monitoring target (display a video of the animal) and store the video when the person sets that the animal is a pet animal of the person.

Presence or absence of the animal is detected using the periphery detection apparatus 9. For example, presence or absence of the animal is detected by an image recognition by visible light, an image recognition by near-infrared light, a temperature recognition by a far-infrared camera, millimeter waves, ultrasonic waves, Lidar, or a sound recognition. When it is dark and the image recognition cannot be performed, the animal may be illuminated, however, in this case, it is sufficient to illuminate the animal with near-infrared light and perform the image recognition by a near-infrared image. When the near-infrared light is applied, a person sleeping in the tent can be prevented from awaking. An operation pattern of the animal is processed using an artificial intelligence (AI) technique, thereby being able to specify a type of the animal.

In Step S15, the controller 5 executes attention-requiring state avoiding processing corresponding to the attention-requiring state. The attention-requiring avoiding processing is executed until the attention-requiring state is avoided. Examples of the attention-requiring state include a state where a moving body (also referred to as “attention-requiring target” hereinafter) including an animal, a suspicious person, and the other vehicle which may cause harm to the monitoring target gets close to the monitoring target. Avoidance of the attention-requiring state includes retreat or blocking of the attention-requiring target or defense of the monitoring target against the attention-requiring target, and is synonymous with resolving the attention-requiring state.

FIG. 6 illustrates an example that the vehicle apparatus 11 (illumination apparatus) illuminates the bear 15 (attention-requiring target) getting close the tent 14 (monitoring target), thereby intending to retreat the bear 15.

In Step S16, the controller 5 determines whether or not the monitoring is finished. Specifically, when predetermined monitoring canceling processing is executed, the monitoring operation (operation in FIG. 3) is finished. In the meanwhile, when the monitoring canceling processing is not executed, the process returns to Step S13. The monitoring canceling processing is executed by performing a monitoring finish operation similar to the monitoring start operation in Step S12.

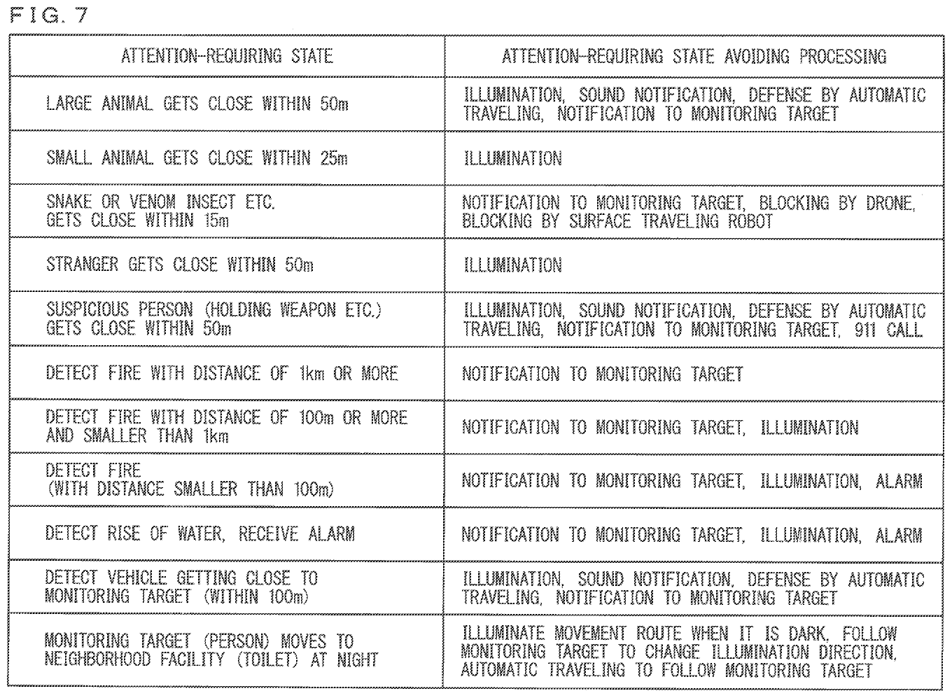

FIG. 7 is a diagram illustrating an example of a relationship between the attention-requiring state and attention-requiring state avoiding processing.

In FIG. 7, “large animal gets close within 50 m” indicates that “large animal gets close within 50 m from monitoring target”, for example. A distance indicated in the other attention-requiring state also indicates a distance from the monitoring target. FIG. 7 illustrates “fire”, however, “natural disaster” is also applicable.

“911 Call” illustrated in FIG. 7 indicates an urgent notice in U.S. The urgent notice is not limited to 911 call, however, it is sufficient an urgent notice corresponding to a country in which the vehicle outside monitoring apparatus 7 is used, such as eCall in Europe, is performed.

In an environment where it is relatively cold around the monitoring target, when a far-infrared imaging apparatus is used as the periphery detection apparatus 9, detection of an animal having a body temperature (particularly, homeothermic animal) can be favorably performed. Small-sized animals, snakes, and harmful insects, for example, have small body sizes, and a detection accuracy of the periphery detection apparatus 9 decreases, thus the imaging apparatus as the periphery detection apparatus 9 may enlarge and take an image near the monitoring target while focusing thereon, thereby increasing the detection accuracy.

It is also applicable to easily recognize eyes of beasts by retina-reflected images using an apparatus in which an illumination device group disposed to surround the imaging apparatus as the periphery detection apparatus 9 is disposed to get close to an optical axis of the imaging apparatus.

Sound which the animal getting close to the monitoring target dislikes (for example, a bark of a natural enemy) may be used as a method of blocking the animal by sound. Illumination, sound, a drug, aroma (gas injection), for example, may be outputted from a drone. Ultrasonic waves do not trouble the monitoring target in the tent.

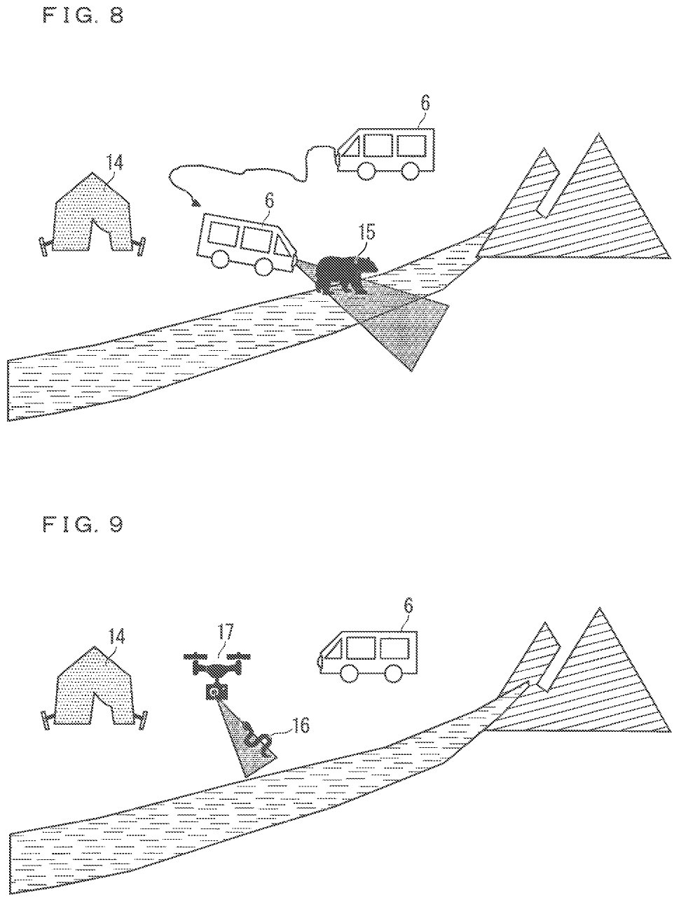

FIG. 8 illustrates a state where the vehicle 6 is moved to a position where the bear 15 is located by automatic driving and subsequently illuminates the bear 15. In this case, the controller 5 controls the automatic driving control apparatus as the vehicle apparatus 11 so that the automatic driving control apparatus makes the vehicle 6 perform automatic driving (an engine or a power source enters the ON state in Step S15), and controls the illumination apparatus as the vehicle apparatus 11 so that the illumination apparatus illuminates the bear 15. The vehicle 6 may illuminate the bear 15 from starting the movement until moving to the position of the bear 15, or may also illuminate the bear 15 when the vehicle 6 gets close to a predetermined distance (for example, 20 m) from the bear 15.

FIG. 9 illustrates a state of blocking a snake 16 getting close to the tent 14 using a drone 17. In this case, the controller 5 controls flying of the drone 17 via a communication apparatus as the vehicle apparatus 11. When the drone 17 includes a built-in imaging apparatus, the vehicle 6, the monitoring target person, and the related person of the vehicle 6 may be notified of a video taken by the imaging apparatus.

It is also applicable to control movement of a small surface movement robot (small robot) in place of the drone 17 to avoid the attention-requiring state.

It is also applicable that the drone and the small robot perform not only the operation of avoiding the attention-requiring state upon receiving the instruction from the vehicle outside monitoring apparatus 7 mounted on the vehicle 6 but also have the other function. For example, the drone and the small robot may transmit a video taken by an imaging apparatus mounted on them in place to the imaging apparatus as the periphery detection apparatus 9 to the vehicle outside monitoring apparatus 7.

### Modification Example 1

Described above is the case where the vehicle 6 executes the operation of avoiding all of the attention-requiring states, however, the configuration is not limited thereto. For example, when the vehicle outside monitoring apparatus 7 notifies the monitoring target person that he/she is in the attention-requiring state, the monitoring target person may execute an operation of avoiding the attention-requiring state by a remote control operation using a communication terminal. In this case, the vehicle 6 has a function of receiving the remote control operation.

### Modification Example 2

In Step S15 in FIG. 3, the same processing is executed until the attention-requiring state is avoided, however, the configuration is not limited thereto. For example, when a state where the attention-requiring state is not avoided continues for a certain period of time, the other processing different from that which has been performed before or a combination of plural types of processing may be executed. That is to say, it is also applicable that first avoiding processing of avoiding the attention-requiring state is performed, and when the attention-requiring state cannot be avoided even after the first avoiding processing is performed, second avoiding processing different from the first avoiding processing is performed.

Specifically, when the animal cannot be blocked by illumination, a sound alarm which the animal dislikes may be outputted in place of or in addition to the illumination. When the animal cannot be still blocked, the vehicle 6 may automatically travel between the animal and the monitoring target to defend the monitoring target by the vehicle 6.

When the animal cannot be blocked by certain sound, for example, sound different from the certain sound may be used. In the similar manner in a case of illumination, when the animal cannot be blocked by certain illumination, it is also applicable to apply a form of blinking light, a difference of intensity of light, or light with a specific shape getting close to the animal or a spot light frequently moving around the animal, for example. In this manner, when the means of blocking the animal is not changed, a parameter or a form may be changed in accordance with a state of the attention-requiring target.

It is also applicable that the attention-requiring state is divided for each level in accordance with a positional relationship between the attention-requiring target and the monitoring target, a type of the attention-requiring target, or an object held by the attention-requiring target, and a higher level of operation of avoiding the attention-requiring state is executed as the level gets higher. The higher level of operation of avoiding the attention-requiring state includes execution of a combination of plural types of processing, for example.

### Modification Example 3

The monitoring target may be a parked vehicle or a facility located around the vehicle 6. An authenticatable communication terminal held by a person may be the monitoring target.

### Modification Example 4

The monitoring target may be a plurality of persons having a specific attribution. For example, it is also applicable that a pupil going to and coming from school is stored as the monitoring target so that a vehicle parked at a specific position in a school route determines whether a suspicious person gets close to the pupil, and when the suspicious person gets close to the pupil, the suspicious person is blocked by sound including a horn or illumination. At the same time, these states may be stored in a video-sound storage apparatus such as a vehicle traveling data recorder, and an urgent notice such as 911 call may also be performed. The urgent notice may be automatically performed.

The person having the specific attribution may be a person having a handicap or an aged wanderer, and in this case, it is sufficient that a related person is notified. A facial image or a cloth of a person may be stored as information regarding the person having the specific attribution to execute the monitoring operation using the information.

### Effect

As described above, according to the embodiment 1, the state of the specific target object other than the subject vehicle or the target person (monitoring target) can be grasped, and when the monitoring target is in the attention-requiring state, it is achievable to appropriately deal with the attention-requiring state.

### Embodiment 2

Described in the embodiment 1 is the case of determining the attention-requiring state of the monitoring target while the vehicle is parked. Described in an embodiment 2 is a case of performing a monitoring operation while a vehicle automatically travels in accordance with a predetermined monitoring plan.

### Configuration

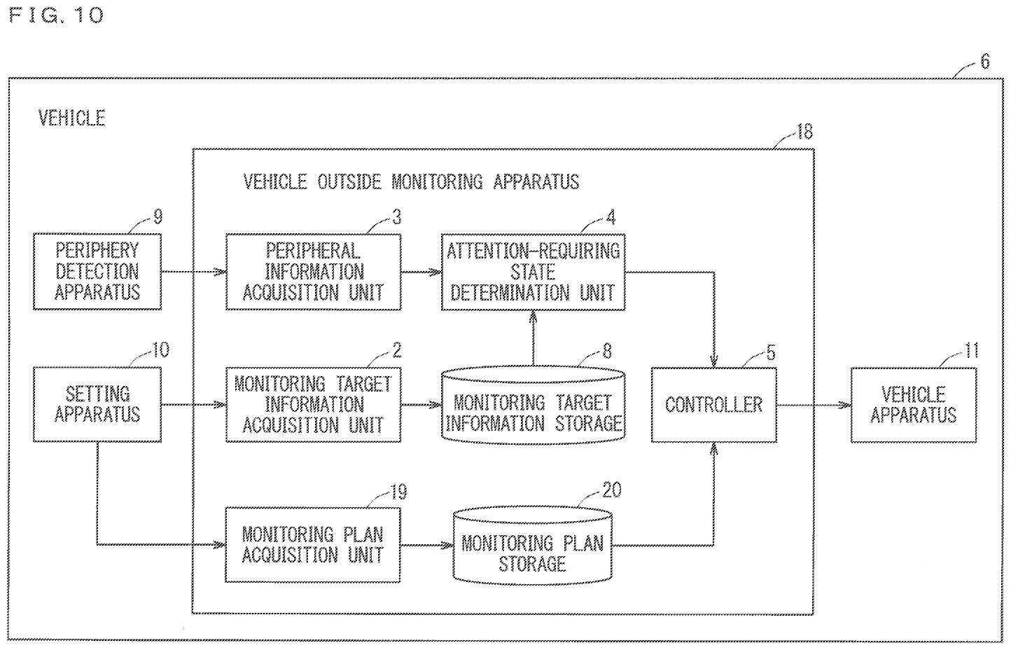

FIG. 10 is a block diagram illustrating an example of a configuration of a vehicle outside monitoring apparatus 18 according to the embodiment 2.

As illustrated in FIG. 10, the vehicle outside monitoring apparatus 18 has a feature that it includes a monitoring plan acquisition unit 19 and a monitoring plan storage 20. The other configuration and basic operation are similar to those in the embodiment 1, thus the detailed description is omitted herein.

The monitoring plan acquisition unit 19 acquires a monitoring plan designed by a user using the setting apparatus 10 (display operation apparatus). The monitoring plan includes a monitoring position as the monitoring target and a monitoring time at which a monitoring operation is performed at the monitoring position.

The monitoring plan storage 20 stores the monitoring plan acquired by the monitoring plan acquisition unit 19. The monitoring plan storage 20 also stores a map database (DB) to set the monitoring position in addition to the monitoring plan. The monitoring plan storage 20 may be provided outside the vehicle outside monitoring apparatus 18.

### Operation

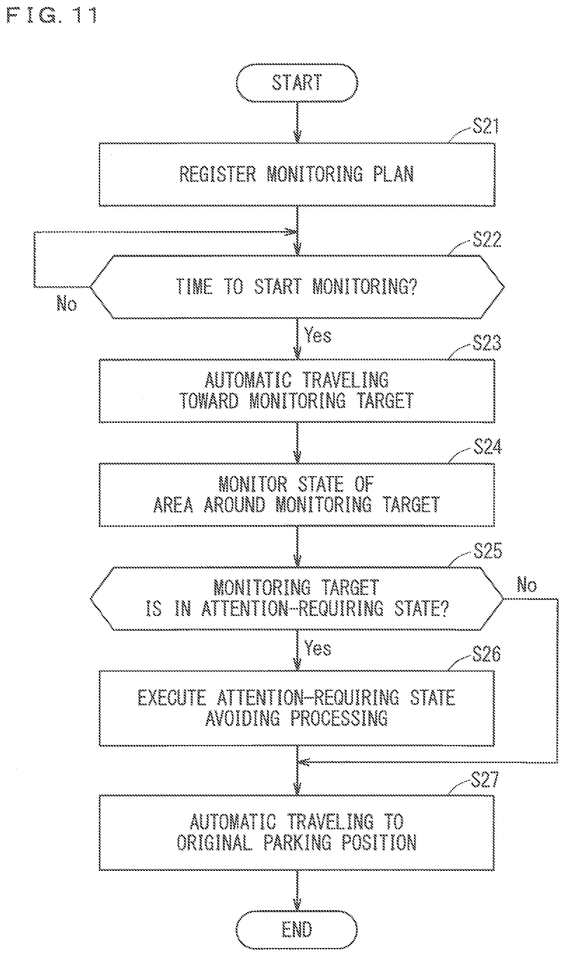

FIG. 11 is a flow chart illustrating an example of an operation of the vehicle outside monitoring apparatus 18.

In Step S21, the user designs the monitoring plan using the setting apparatus 10 (display operation apparatus). The monitoring plan acquisition unit 19 acquires the designed monitoring plan and stores it in the monitoring plan storage 20. Accordingly, the monitoring plan is registered in the vehicle outside monitoring apparatus 18.

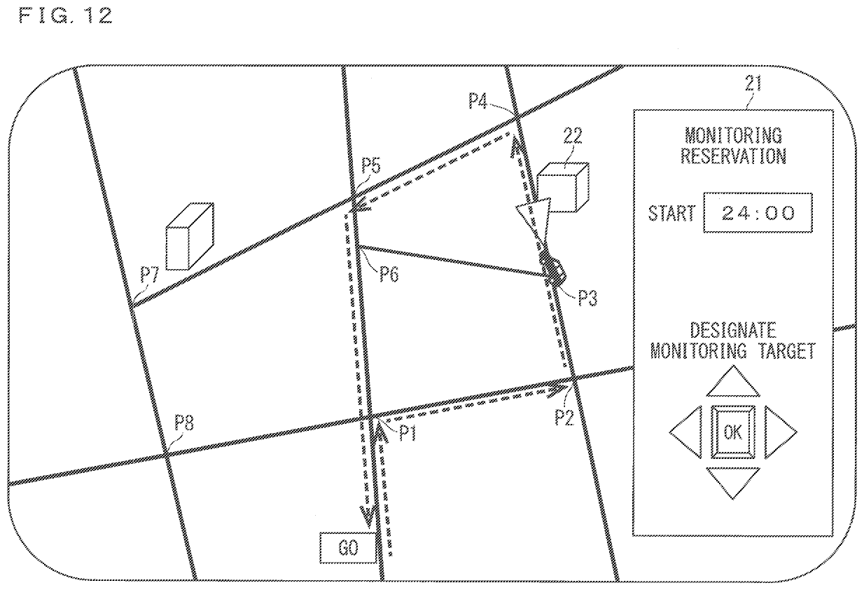

For example, a monitoring plan design screen illustrated in FIG. 12 is displayed on the display operation apparatus. The monitoring plan design screen includes a map and a setting window 21. The user sets a monitoring target 22 by an operation similar to a setting of a destination in a car navigation system, for example. “GO” displayed on the map indicates a position where the vehicle 6 performing the monitoring operation stands ready.

A time (monitoring time) at which the monitoring operation is started in a position where the monitoring target 22 is located is shown in an upper portion of the setting window 21 (monitoring reservation). The time is set by inputting data of the time using a software keyboard provided to the setting apparatus 10 (display operation apparatus), for example. Located on a lower portion of the setting window 21 (monitoring target designation) are a button for moving a cursor (not shown) displayed on the screen from side to side and up and down and a determination button determining the monitoring target. In the example in FIG. 12, the user moves the cursor to be overlapped with a building corresponding to the monitoring target 22 and selects the determination button. Accordingly, the selected building is set as the monitoring target 22. Although not shown in FIG. 12, a button for scrolling the map or a button for zooming the map may be located in the setting window 21.

In the example in FIG. 12, the building is set to the monitoring target 22, and the monitoring time is set to 24:00. The setting apparatus 10 performs processing similar to a route search performed by a car navigation system based on the monitoring target 22 and the standby position “GO” of the vehicle 6, and sets a route starting from GO, passing through the monitoring target 22, and returning to GO again. The route is a route (dashed arrow in FIG. 12) passing through GO, P1, P2, P3, P4, P5, P6, P1, and GO in this order, for example. The setting apparatus 10 sets a start time t (GO) for passing through an area near the monitoring target 22 at a time t (22)=24:00 in consideration of a standard travel speed. In this manner, the setting apparatus 10 has a function similar to the car navigation system.

In Step S22, the controller 5 stands ready until a time of starting monitoring (start time t (GO)) comes. When the time of starting monitoring (start time t (GO)) comes, the process proceeds to Step S23.

In Step S23, the controller 5 controls the vehicle apparatus 11 (automatic traveling control apparatus) so that the vehicle 6 automatically travels along a route which has been set. Accordingly, the vehicle 6 starts automatic traveling toward the monitoring target 22.

In Step S24, when the vehicle 6 travels a section from P3 to P4, the attention-requiring state determination unit 4 monitors a state around the monitoring target 22. A process in Step S24 is similar to that in Step S13 in FIG. 3. The controller 5 may control the vehicle apparatus 11 so that the vehicle 6 slow down while traveling the section from P3 to P4. Accordingly, a time of monitoring the state around the monitoring target 22 can be increased.

In Step S25, the attention-requiring state determination unit 4 determines whether or not the monitoring target 22 is in the attention-requiring state. When the monitoring target 22 is in the attention-requiring state, the process proceeds to Step S26. In the meanwhile, when the monitoring target 22 is not in the attention-requiring state, the process proceeds to Step S27. The process in Step S25 is similar to that in Step S14 in FIG. 3.

Examples of the attention-requiring state herein include a state where a suspicious person (attention-requiring target) gets close to the monitoring target 22, a suspicious person intrudes into the monitoring target 22, or a suspicious person sets fire to the monitoring target 22, for example. An event of monitoring the area around the monitoring target 22 may be set in the monitoring plan design screen, and a predetermined monitoring category (monitoring situation) may be set. The monitoring category includes security of a building, security of a person, and a camp, for example. The monitored event may be associated in accordance with the monitoring category. As for the determination of the suspicious person, it is sufficient that a person is determined to be the suspicious person when a cloth, a behavior, and a belonging of the person satisfy a predetermined condition.

In Step S26, the controller 5 executes attention-requiring state avoiding processing corresponding to the attention-requiring state. The attention-requiring avoiding processing is executed until the attention-requiring state is avoided. The process in Step S26 is similar to that in Step S15 in FIG. 3.

Notification to the related person of the monitoring target 22 or notification of a video indicating the attention-requiring state may be performed as the attention-requiring state avoiding processing, for example. Sound notification or illumination may be performed on the suspicious person by the vehicle 6. A video or sound indicating the attention-requiring state may be recorded.

In Step S27, when the vehicle 6 passes through a position where the monitoring target 22 is located, the controller 5 controls the vehicle apparatus 11 so that the vehicle 6 automatically travels to GO as the start position in accordance with a route which has been set. When the vehicle 6 reaches GO, the operation in FIG. 11 is finished.

### Modification Example 1

The case of setting one monitoring target is described above, however, the plurality of monitoring targets may be set. For example, in FIG. 12, it is applicable to design, as one plan, to continuously perform the monitoring plan on a building near P7 after performing the monitoring operation (operation in FIG. 11) on the monitoring target 22, or separately design the monitoring plan on each of the monitoring targets. When the plurality of monitoring targets are designed to be monitored as one plan, a route along which the vehicle 6 automatically travels is a route passing through GO, P1, P2, P3, P4, P5. P7, P8, P1, and GO in this order.

### Modification Example 2

Described above is the case of performing the monitoring operation at the time of passing through the monitoring target, however, the configuration is not limited thereto. A period during which the monitoring operation is performed (monitoring period) may be set.

For example, when the monitoring period is set to 20 minutes in FIG. 12, the vehicle 6 may stop at 24:00 to 24:20 to perform the monitoring operation in accordance with traffic rules of the area near the monitoring target 22. When parking and stopping of a vehicle is prohibited near the monitoring target 22, the vehicle 6 may travel around P3, P4, P5, P6, and P3 in this order to perform the monitoring operation several times.

### Modification Example 3

The case where the monitoring target is the building is described above, however, a predetermined route (monitoring travel route) may be the monitoring target. For example, in FIG. 12, a section (area) from P2 to P4 may be the monitoring target. In this case, anti-crime measures (measures against property loss or fire-setting, for example) can be performed in the section which has been set.

### Modification Example 4

Described above is the case where the monitoring operation is performed on the monitoring target once, however, the monitoring operation may be performed on the same monitoring target several times in a predetermined period of time. The monitoring operation may be performed on the same monitoring target twice at 24:00 and 2:00, for example. The monitoring operation may be performed every two hours between 22:00 to 4:00 in the next day.

### Modification Example 5

Described above is the case where the vehicle 6 designs the monitoring plan, however, the configuration is not limited thereto. For example, it is applicable to design the monitoring plan by a communication terminal authenticatable as an owner of the vehicle 6 and transmit the designed monitoring plan to the setting apparatus 10 (communication apparatus) of the vehicle 6.

### Effect

As described above, according to the embodiment 2, the vehicle automatically travels in accordance with the predetermined monitoring plan, thus the state of the specific target object other than the subject vehicle or the target person (monitoring target) can be grasped, and when the monitoring target is in the attention-requiring state, it is achievable to appropriately deal with the attention-requiring state.

### Embodiment 3

Described in the embodiment 1 is the case where the owner of the vehicle including the built-in vehicle outside monitoring apparatus sets the monitoring target, for example. Described in an embodiment 3 is a case where a monitoring service center mediates between a client requesting monitoring and an owner of a vehicle including a built-in vehicle outside monitoring apparatus.

### Configuration

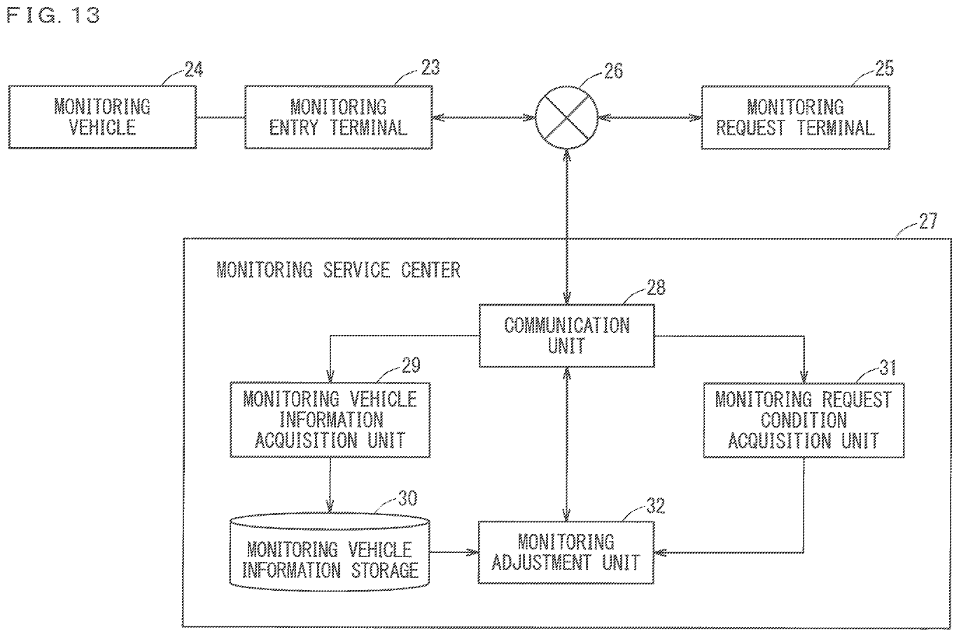

FIG. 13 is a block diagram illustrating an example of a configuration of a monitoring service center 27 according to the embodiment 3. A monitoring entry terminal 23, a monitoring request terminal 25, and the monitoring service center 27 are communicably connected via a communication network 26.

The monitoring entry terminal 23 is a terminal used when an owner of a monitoring vehicle 24 perform communication with the monitoring service center 27. The monitoring vehicle 24 corresponds to the vehicle including the built-in vehicle outside monitoring apparatus described in the embodiments 1 and 2. The vehicle outside monitoring apparatus mounted on the monitoring vehicle 24 may have a function of the monitoring entry terminal 23. In this case, the monitoring entry terminal 23 is unnecessary.

The monitoring request terminal 25 is a terminal used when a client requesting monitoring (monitoring client) performs communication with the monitoring service center 27. The monitoring request terminal 25 may have a function of performing communication with the vehicle outside monitoring apparatus 18 mounted on the monitoring entry terminal 23 or the monitoring vehicle 24.

The monitoring service center 27 includes a communication unit 28, a monitoring vehicle information acquisition unit 29, a monitoring vehicle information storage 30, a monitoring request condition acquisition unit 31, and a monitoring adjustment unit 32.

The communication unit 28 performs communication with the monitoring entry terminal 23 and the monitoring request terminal 25.

The monitoring vehicle information acquisition unit 29 acquires monitoring vehicle information transmitted from the monitoring entry terminal 23 via the communication unit 28. The monitoring vehicle information includes a monitoring enabling condition, information regarding the monitoring entry terminal 23, information regarding the monitoring vehicle 24, information regarding entry of the monitoring enabling condition, information regarding canceling of the monitoring enabling condition, and information regarding change of the monitoring enabling condition, for example. The monitoring enabling condition indicates a condition that the monitoring target can be monitored. Examples of the monitoring enabling condition include a position of a monitoring vehicle, a monitoring direction (orientation of a traveling direction of the monitoring vehicle), a monitoring enabling time, and an implementable attention-requiring state avoiding processing.

The monitoring vehicle information storage 30 stores the monitoring vehicle information in which the monitoring enabling condition, the monitoring entry terminal 23, and the monitoring vehicle 24 are associated with each other. The monitoring vehicle information storage 30 may be provided outside the monitoring service center 27.

The monitoring request condition acquisition unit 31 acquires the monitoring request condition transmitted from the monitoring request terminal 25 via the communication unit 28. The monitoring request condition indicates a condition that monitoring of the monitoring target is requested. Examples of the monitoring request condition include information regarding the monitoring target, a reservation time of performing monitoring, and a route of performing monitoring (monitoring route).

The monitoring adjustment unit 32 performs adjustment so that an owner of the monitoring vehicle and a monitoring client enter into a monitoring engagement based on the monitoring vehicle information and the monitoring request condition. The monitoring adjustment unit 32 also has a function of controlling the whole monitoring service center 27.

### Operation

The operation of the monitoring service center 27 is broadly divided into an operation performed when the monitoring vehicle information is received from the monitoring entry terminal 23 and an operation performed when the monitoring request condition is received from the monitoring request terminal 25. In the description hereinafter, these two operations are performed in parallel, however, any program processing or program configuration is applicable as long as it can execute a necessary function.

### Operation Performed when Monitoring Vehicle Information is Received from Monitoring Entry Terminal 23

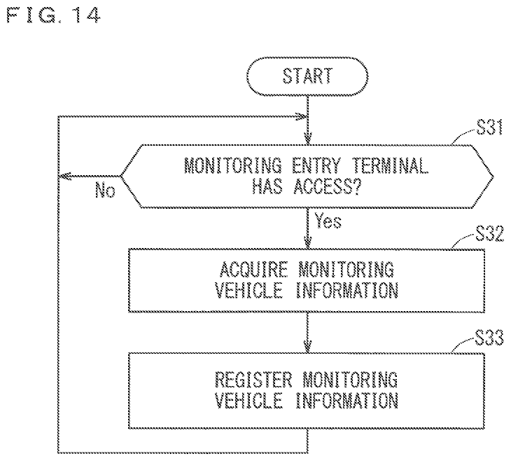

FIG. 14 is a flow chart illustrating an example of an operation of the monitoring service center 27, and illustrates an operation of receiving the monitoring vehicle information from the monitoring entry terminal 23.

In Step S31, the communication unit 28 stands ready until the monitoring entry terminal 23 has access thereto. When the monitoring entry terminal 23 has access, the process proceeds to Step S32.

In Step S32, the monitoring vehicle information acquisition unit 29 acquires monitoring vehicle information from the monitoring entry terminal 23.

In Step S33, the monitoring vehicle information acquisition unit 29 stores the acquired monitoring vehicle information in the monitoring vehicle information storage 30. Accordingly, the monitoring vehicle information is registered in the monitoring service center 27. When the monitoring vehicle information regarding the monitoring vehicle 24 which has been already registered is stored in the monitoring vehicle information storage 30, new monitoring vehicle information regarding the registered monitoring vehicle 24 is overwritten and updated. When the plurality of monitoring vehicles 24 are located, the monitoring vehicle information for each monitoring vehicle 24 is stored in the monitoring vehicle information storage 30.

The process in Step S31 to Step S33 is continuously executed as long as the monitoring service center 27 is activated. The process in Step S31 to Step S33 may be executed at regular or irregular intervals.

### Operation Performed when Monitoring Request Condition is Received from Monitoring Request Terminal 25

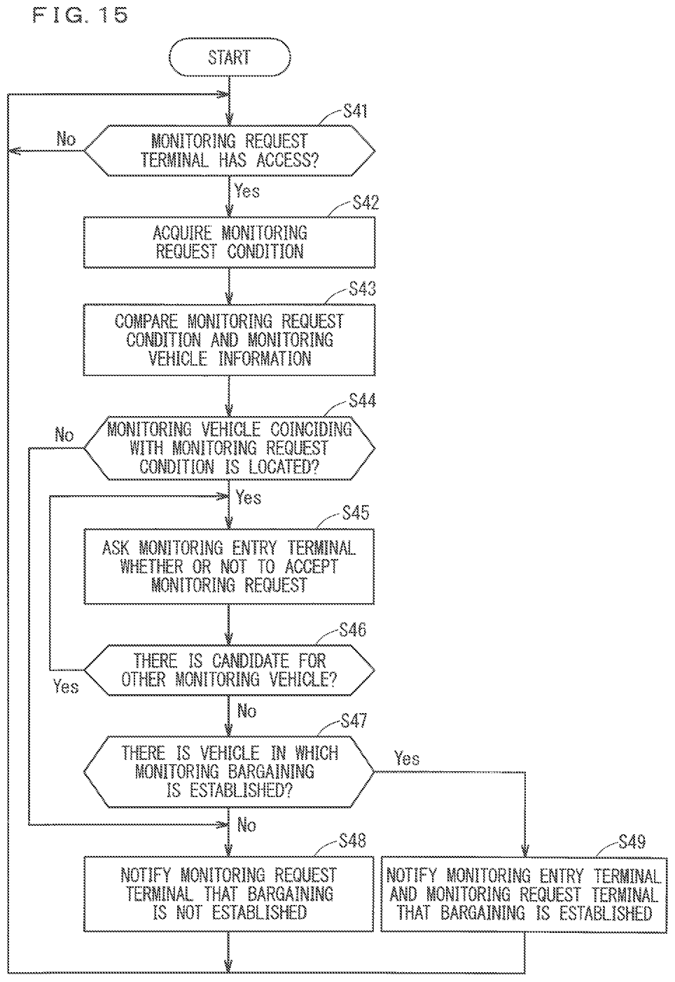

FIG. 15 is a flow chart illustrating an example of an operation of the monitoring service center 27, and illustrates an operation of receiving the monitoring request condition from the monitoring request terminal 25.

In Step S41, the communication unit 28 stands ready until the monitoring request terminal 25 has access thereto. When the monitoring request terminal 25 has access, the process proceeds to Step S42.

In Step S42, the communication unit 28 suggests a predetermined monitoring request screen to the monitoring request terminal 25 to acquire the monitoring request condition designated by the monitoring client.

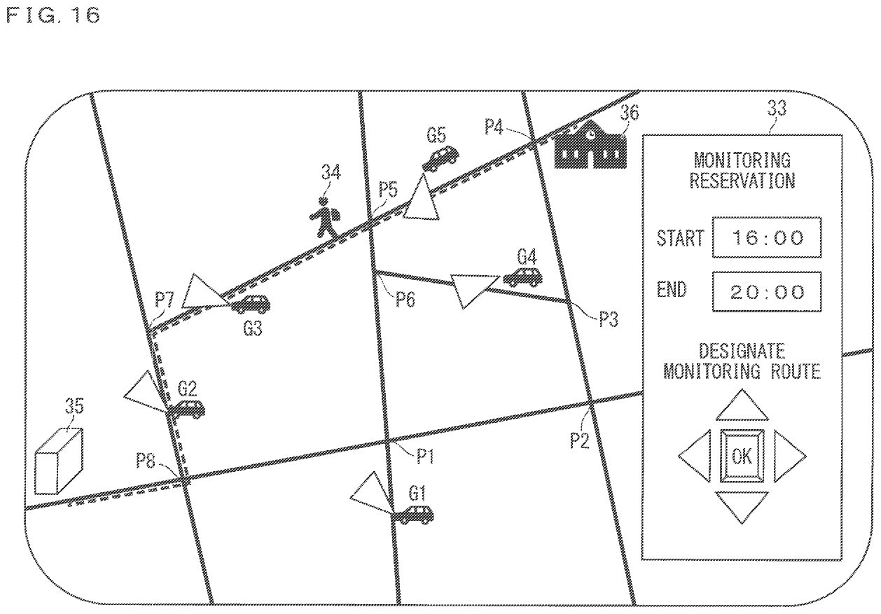

FIG. 16 is a diagram illustrating an example of a monitoring request screen. For example, the monitoring client operates the monitoring request terminal 25, thereby displaying the monitoring request screen including a map on the monitoring request terminal 25. Indicated on the map are positions of registered monitoring vehicles G1 to G5 (positions of icons indicating vehicles G1 to G5) and monitoring directions (directions indicated by triangle marks) stored in the monitoring vehicle information storage 30. A method of expressing a monitoring direction and a monitoring range is not limited to the triangle mark. For example, a fan-like shape imitating illumination may be adopted, and the monitoring range for each monitoring vehicle may be expressed by an inner angle, a direction, and a size of the fan-like shape.

The monitoring request screen includes a setting window 33. A reservation time at which the monitoring vehicle 24 performs monitoring in a designated monitoring route is indicated in an upper portion of the setting window 33 (monitoring reservation). The time is set by inputting data of the time using a software keyboard provided to the setting apparatus 10 (display operation apparatus), for example. In the example in FIG. 16, 16:00 to 20:00 is designated as the reservation time of monitoring. The plurality of reservation times may be designated.

Located on a lower portion of the setting window 33 (monitoring route designation) are a button for moving a cursor (not shown) displayed on the screen from side to side and up and down and a determination button designating a predetermined point (for example, P1 to P8, building) on the monitoring route. In the example in FIG. 16, the monitoring client designates each point of a home 35, P8, P7, P5, P4, and a school 36.

Accordingly, a route from the home 35 to the school 36 (route indicated by dashed line) is set as the monitoring route.

Furthermore, the monitoring client sets a type (elementary school student, junior high school student, or high school student, for example) or a picture of a monitoring target 34 as information regarding the monitoring target 34 by an operation not shown in FIG. 16. A position of the monitoring target 34 illustrated in FIG. 16 may be designated by the monitoring client as a position where the monitoring target 34 may be located at the reservation time of monitoring.

Returning to the description of FIG. 15, in Step S43, the monitoring adjustment unit 32 compares the monitoring vehicle information registered in the monitoring vehicle information storage 30 and the monitoring request condition acquired by the monitoring request condition acquisition unit 31.

In Step S44, the monitoring adjustment unit 32 determines whether or not the monitoring vehicle coinciding with the monitoring request condition is located. When the monitoring vehicle 24 coinciding with the monitoring request condition is located, the process proceeds to Step S45. In the meanwhile, when the monitoring vehicle 24 coinciding with the monitoring request condition is not located, the process proceeds to Step S48. In the example in FIG. 16, the monitoring vehicles G2, G3, and G5 are located on the monitoring route, thus it is determined that the monitoring vehicle 24 coinciding with the monitoring request condition is located.

In Step S45, the monitoring adjustment unit 32 asks the monitoring entry terminal 23 whether or not to accept the monitoring request via the communication unit 28. In the example in FIG. 16, the monitoring adjustment unit 32 notifies the monitoring entry terminal 23 held by each owner of the monitoring vehicles G2, G3, and G5 whether to accept the monitoring request. Then, the monitoring adjustment unit 32 receives an answer whether or not to accept the monitoring request from each monitoring entry terminal 23.

In Step S46, the monitoring adjustment unit 32 determines whether or not there is a candidate for the other monitoring vehicle 24. When there is a candidate for the other monitoring vehicle 24, the process returns to Step S45. In the meanwhile, when there is no candidate for the other monitoring vehicle 24, the process proceeds to Step S47. In the example in FIG. 16, when the monitoring adjustment unit 32 receives the answer from all of the monitoring entry terminals 23 regarding the monitoring vehicles G2, G3, and G5, the process proceeds to Step S47.

In Step S47, the monitoring adjustment unit 32 determines whether or not there is a vehicle in which a monitoring bargaining is established. Specifically, when the monitoring adjustment unit 32 receives the answer indicating that the monitoring request is accepted from at least one monitoring entry terminal 23 in Step S45, the monitoring adjustment unit 32 determines that there is a vehicle in which a monitoring bargaining is established. When the monitoring adjustment unit 32 does not receive the answer indicating that the monitoring request is accepted from any monitoring entry terminal 23 in Step S45, the monitoring adjustment unit 32 determines that a monitoring bargaining is not established. When there is a vehicle in which a monitoring bargaining is established, the process proceeds to Step S48. In the meanwhile, when there is no vehicle in which a monitoring bargaining is established, the process proceeds to Step S49.

In Step S48, the monitoring adjustment unit 32 transmits the notification that the bargaining is not established to the monitoring request terminal 25 via the communication unit 28.

In Step S49, the monitoring adjustment unit 32 transmits the notification that the bargaining is established to each of the monitoring entry terminal 23 and the monitoring request terminal 25 via the communication unit 28. The monitoring adjustment unit 32 suggests a method of exchanging information between the monitoring entry terminal 23 and the monitoring request terminal 25. Subsequently, the monitoring vehicle 24 in which the bargaining is established performs the monitoring operation in accordance with the monitoring request. Then, when the monitoring vehicle 24 determines that the monitoring target is in the attention-requiring state, the monitoring vehicle 24 executes an attention-requiring state avoiding operation similar to that in the embodiment 1. At this time, the monitoring vehicle 24 starts the monitoring operation while being parked, however, the monitoring vehicle 24 may be moved at an ultralow speed (for example, 1 km per hour) within a range in which the monitoring vehicle 24 can monitor the monitoring target. In this manner, the monitoring vehicle 24 can be moved to some extent to increase a range in which the monitoring vehicle 24 can monitor the monitoring target. The monitoring operation may be continued while moving the monitoring vehicle 24 at a low speed.

It is also applicable that the monitoring service center 27 obtains a counter value from the monitoring client, and pays an owner of the monitoring vehicle 24 in which the bargaining is established for the monitoring operation.

The monitoring vehicle 24 may be a vehicle owned by an individual having a contract with the monitoring service center 27, or may also be a vehicle owned by the monitoring service center 27.

The monitoring vehicle 24 transmits a message that a child as the monitoring target has passed through a point where the monitoring vehicle 24 is located to the monitoring client. In this case, the monitoring client can rapidly recognize a state of his/her child, thus can achieve a sense of safety. When the message does not come from the monitoring vehicle 24 even after a scheduled time, the monitoring client can rapidly take a measure of notifying police, for example.

### Modification Example 1

In FIG. 16, the monitoring route is requested as the range of performing the monitoring operation, and the monitoring operation is requested to the plurality of monitoring vehicles on the monitoring route, however, the configuration is not limited thereto. The monitoring target may be a point such as a building or a facility. In this case, it is also applicable that one monitoring vehicle closest to the point of the monitoring target is selected, and the monitoring operation is requested to the one monitoring vehicle.

### Modification Example 2

When the monitoring bargaining is established with the plurality of monitoring vehicles 24 in Step S47 in FIG. 15, the plurality of monitoring vehicles 24 may perform the monitoring operation in Step S49. In this case, each monitoring vehicle 24 may perform the monitoring operation in cooperation with each other.

### Modification Example 3

Described above is the case of performing the monitoring operation while parking the monitoring vehicle 24, and performing the operation including automatic traveling to avoid the attention-requiring state when the monitoring target is in the attention-requiring state, however, the configuration is not limited thereto. For example, as described in the embodiment 2, also applicable is the monitoring service center 27 to which monitoring can be requested in a position which has been set at a reservation time which has been set. In this case, in the manner similar to the embodiment 2, the monitoring vehicle 24 automatically travels to the monitoring target at the reservation time to perform the monitoring operation, and returns to an original standby position when finishing the monitoring operation.

### Modification Example 4

The monitoring service center 27 may rapidly request the monitoring entry terminal 23 to start the monitoring operation by the monitoring vehicle 24 upon receiving an urgent monitoring request from the monitoring request terminal 25.

### Effect

As described above, according to the embodiment 3, the monitoring service center mediates between the client requesting monitoring and the owner of the monitoring vehicle including the built-in vehicle outside monitoring apparatus, thus the state of the specific target object other than the vehicle or the target person (monitoring target) can be grasped, and when the monitoring target is in the attention-requiring state, it is achievable to appropriately deal with the attention-requiring state.

### Hardware Configuration

Each function of the monitoring target information acquisition unit 2, the periphery information acquisition unit 3, the attention-requiring state determination unit 4, and the controller 5 in the vehicle outside monitoring apparatus 7 described in the embodiment 1 is achieved by a processing circuit. That is to say, the vehicle outside monitoring apparatus 7 includes a processing circuit for performing control of acquiring the monitoring target information, acquiring the peripheral information, determining whether or not the monitoring target is in the attention-requiring state, and avoiding the attention-requiring state when the monitoring target is in the attention-requiring state. The processing circuit may be dedicated hardware or a processor (also referred to as a CPU, a central processor, a processing device, an arithmetic device, a microprocessor, a microcomputer, or a digital signal processor (DSP)) executing a program stored in a memory.

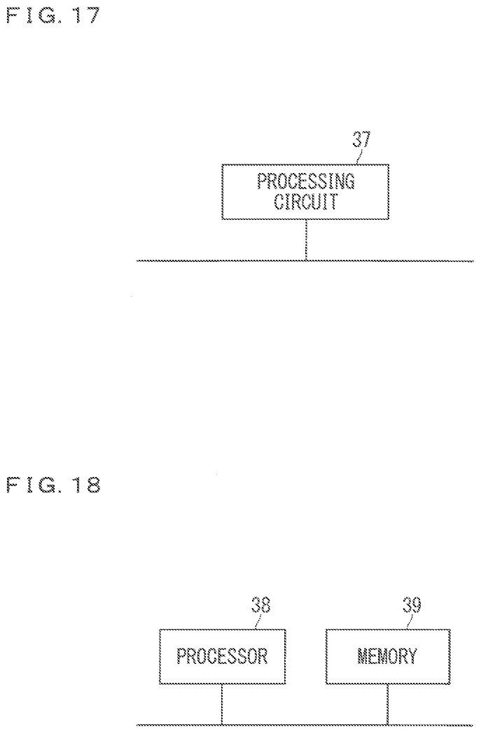

When the processing circuit is the dedicated hardware, a single circuit, a complex circuit, a programmed processor, a parallel-programmed processor, an application specific integrated circuit (ASIC), a field-programmable gate array (FPGA), or a combination of them, for example, falls under a processing circuit 37 as illustrated in FIG. 17. Each function of the monitoring target information acquisition unit 2, the periphery information acquisition unit 3, the attention-requiring state determination unit 4, and the controller 5 may be achieved by the processing circuit 37 or each function may be collected to be achieved by one processing circuit 37.

When the processing circuit 37 is a processor 38 illustrated in FIG. 18, each function of the monitoring target information acquisition unit 2, the periphery information acquisition unit 3, the attention-requiring state determination unit 4, and the controller 5 is achieved by software, firmware, or a combination of software and firmware. The software or the firmware is described as a program and is stored in a memory 39. The processor 38 reads out and executes a program stored in the memory 39, thereby achieving each function. That is to say, the vehicle outside monitoring apparatus 7 includes the memory 39 for storing a program resultingly executing a step of acquiring the monitoring target information, a step of acquiring the peripheral information, a step of determining whether or not the monitoring target is in the attention-requiring state, and a step of performing control so that the attention-requiring state is avoided when the monitoring target is in the attention-requiring state. These programs are also deemed to make a computer execute procedures or methods of the monitoring target information acquisition unit 2, the periphery information acquisition unit 3, the attention-requiring state determination unit 4, and the controller 5. Herein, a memory may be a non-volatile or volatile semiconductor memory such as a random access memory (RAM), a read only memory (ROM), a flash memory, an erasable programmable read only memory (EPROM), and an electrically erasable programmable read only memory (EEPROM), or, a magnetic disc, a flexible disc, an optical disc, a compact disc, a digital versatile disc (DVD), or any storage medium which is to be used in the future.

It is also applicable that some of each function of the monitoring target information acquisition unit 2, the periphery information acquisition unit 3, the attention-requiring state determination unit 4, and the controller 5 is achieved by dedicated hardware and the other function thereof is achieved by software or firmware.

As described above, the processing circuit can achieve each function described above by the hardware, the software, the firmware, or the combination of them.

A hardware configuration of the vehicle outside monitoring apparatus 7 described in the embodiment 1 is described above, however, the same applies to a hardware configuration of the vehicle outside monitoring apparatus 18 described in the embodiment 2 and a hardware configuration of the monitoring service center 27 described in the embodiment 3.

Each embodiment can be arbitrarily combined, or each embodiment can be appropriately varied or omitted within the scope of the invention.

Although the present disclosure is described in detail, the foregoing description is in all aspects illustrative and does not restrict the disclosure. It is therefore understood that numerous modification examples can be devised.

### EXPLANATION OF REFERENCE SIGNS

1 vehicle outside monitoring apparatus, 2 monitoring target information acquisition unit, 3 peripheral information acquisition unit, 4 attention-requiring state determination unit, 5 controller, 6 vehicle, 7 vehicle outside monitoring apparatus, 8 monitoring target information storage, 9 periphery detection apparatus, 10 setting apparatus 11 vehicle apparatus, 12 setting window, 13 cursor, 14 tent, 15 bear, 16 snake, 17 drone, 18 vehicle outside monitoring apparatus, 19 monitoring plan acquisition unit, 20 monitoring plan storage, 21 setting window, 22 monitoring target, 23 monitoring entry terminal, 24 monitoring vehicle, 25 monitoring request terminal, 26 communication network, 27 monitoring service center, 28 communication unit, 29 monitoring vehicle information acquisition unit, 30 monitoring vehicle information storage, 31 monitoring request condition acquisition unit, 32 monitoring adjustment unit, 33 setting window, 34 monitoring target, 35 home, 36 school, 37 processing circuit, 38 processor, 39 memory.

1.-22. (canceled)

23. A vehicle outside monitoring apparatus, comprising:
a processor to execute a program; and
a memory to store the program which, when executed by the processor, performs processes of,
acquiring monitoring target information including a relative position of a monitoring target in relation to a subject vehicle or an absolute position of the monitoring target before a monitoring operation is executed on the monitoring target located around the subject vehicle;
acquiring periphery information as information around the subject vehicle;
determining whether or not the monitoring target is in an attention-requiring state based on the monitoring target information which has been acquired and the periphery information which has been acquired; and
controlling the subject vehicle so that the subject vehicle avoids the attention-requiring state when it is determined that the monitoring target is in the attention-requiring state.

24. The vehicle outside monitoring apparatus according to claim 23, wherein
the monitoring target information of the monitoring target selected in a video by a user is acquired.

25. The vehicle outside monitoring apparatus according to claim 23, wherein
the attention-requiring state includes a state where a moving body including a predetermined animal, a suspicious person, and another vehicle gets close to the monitoring target.

26. The vehicle outside monitoring apparatus according to claim 23, wherein
the attention-requiring state includes a state where fire or a natural disaster gets close to the monitoring target in a static state within a predetermined distance.

27. The vehicle outside monitoring apparatus according to claim 26, wherein
the attention-requiring state includes a state where a person as the monitoring target walks at night, and
the subject vehicle is controlled so that the subject vehicle illuminates an area around the person when the person walks.

28. The vehicle outside monitoring apparatus according to claim 25, wherein
the subject vehicle is controlled so that the subject vehicle outputs sound to the animal or illuminates the animal in accordance with a type of the animal.

29. The vehicle outside monitoring apparatus according to claim 25, wherein
automatic traveling of the subject vehicle is controlled so that the subject vehicle blocks the moving body or defends the monitoring target from the moving body.

30. The vehicle outside monitoring apparatus according to claim 25, wherein
a small robot or a drone mounted on the subject vehicle is controlled so that the small robot or the drone blocks the moving body or defends the monitoring target from the moving body.

31. The vehicle outside monitoring apparatus according to claim 25, wherein
a first avoiding process of avoiding the attention-requiring state is performed by sound or illumination, and performed is a second avoiding process of making the subject vehicle automatically travel between the moving body and the monitoring target to defend the monitoring target when the attention-requiring state cannot be avoided by the first avoiding process.

32. The vehicle outside monitoring apparatus according to claim 23, wherein
performed is control of notifying the monitoring target or a related person of the monitoring target of the attention-requiring state.

33. The vehicle outside monitoring apparatus according to claim 23, wherein
the monitoring target information including an absolute position of the monitoring target is acquired from the related person of the monitoring target, and is recorded.

34. The vehicle outside monitoring apparatus according to claim 23, wherein
the monitoring target is a moving body including a person.

35. The vehicle outside monitoring apparatus according to claim 23, wherein
the monitoring target is a facility where a person stays.

36. The vehicle outside monitoring apparatus according to claim 23, wherein
controlled is the subject vehicle so that the subject vehicle automatically travels to the monitoring target based on a monitoring plan including a predetermined monitoring position, a predetermined monitoring time, and a predetermined monitoring travel route.

37. The vehicle outside monitoring apparatus according to claim 23, wherein
the monitoring travel route includes the plurality of monitoring targets.

38. The vehicle outside monitoring apparatus according to claim 23, wherein
the monitoring target includes a monitoring target category, and an event to be monitored is set in accordance with the monitoring target category.

39. A monitoring service center, comprising:
a processor to execute a program, and
a memory to store the program which, when executed by the processor, performs processes of,
acquiring monitoring vehicle information including a monitoring enabling condition as a condition that the monitoring target can be monitored from a monitoring vehicle as the subject vehicle including the vehicle outside monitoring apparatus according to claim 1 therein;
acquiring a monitoring request condition as a condition that monitoring of the monitoring target is requested; and
performing adjustment so that the monitoring vehicle and a monitoring client requesting the monitoring enter into a monitoring engagement based on the monitoring vehicle information which has been acquired and the monitoring request condition which has been acquired.

40. The monitoring service center according to claim 39, wherein
the monitoring request condition includes a condition that at least one of a predetermined facility, a moving body including a predetermined person, and a predetermined area is set to the monitoring target.

41. The monitoring service center according to claim 39, wherein
the monitoring enabling condition includes at least one of monitoring from a position where the monitoring vehicle is parked, monitoring by automatic traveling of the monitoring vehicle, and a monitoring enabling time.

42. A vehicle outside monitoring method, comprising:
acquiring monitoring target information including a relative position of a monitoring target in relation to a subject vehicle or an absolute position of the monitoring target before a monitoring operation is executed on the monitoring target located around the subject vehicle;
acquiring periphery information as information of an area around the subject vehicle;
determining whether or not the monitoring target is in an attention-requiring state based on the monitoring target information which has been acquired and the periphery information which has been acquired; and
controlling the subject vehicle so that the subject vehicle avoids the attention-requiring state when it is determined that the monitoring target is in the attention-requiring state.
